(19) United States
(12) Patent Application Publication
(10) Pub. No.: US 2015/0251937 A1
(43) Pub. Date: Sep. 10, 2015

(54) Method and an apparatus for simultaneous removal of thiosalts and nitrogen compounds in waste water

(71) Applicant: Boliden Mineral AB, Skellefteham (SE)

(72) Inventors: Jan-Eric Sundkvist, Skelleftehamn (SE); Amang Saleh, Skelleftehamn (SE)

(21) Appl. No.: 14/430,916

(22) PCT Filed: Sep. 20, 2013
(86) PCT No.: PCT/EP2013/069541

§ 371 Date: Mar. 25, 2015

(30) Foreign Application Priority Data
Sep. 25, 2012 (SE) 1251085-5

(51) Int. Cl. C02F 3/08; C02F 3/34

(52) U.S. Cl. CPC C02F 3/08; C02F 3/34; C02F 2101/101

(57) ABSTRACT

The present invention relates to a method and as apparatus for simultaneous removal of thiosalts and nitrogen compounds in waste water, wherein the amount of thiosalts in the waste water is larger than the stoichiometric demand for the autotrophic nitrogen removal. The apparatus comprises a bioreactor (1) including an autotrophic bacteria culture carrying out a denitrification process using the thiosalts as electron donors, having an inlet (3) for receiving the waste water, and an outlet (4) for discharging the purified water. The apparatus comprises an oxygen supply device (6) arranged to supply oxygen to the water in the reactor and a control unit (10) arranged to control the content of dissolved oxygen in the reactor such that the excess of thiosalts is oxidized by the oxygen at the same time as the denitrification process is maintained.

### FIELD OF THE INVENTION

The present invention relates to a bacteria assisted method and an apparatus for treating water including thiosalts, such as thiosulphate and tetrathionate, and nitrogen compounds, such as nitrite, nitrate and ammonia, wherein the amount of thiosalts in the waste water is larger than the stoichiometric demand for the autotrophic nitrogen removal. The water is treated with an autotrophic denitrification process using the thiosalts as electron donor.

PRIOR ART

Water from mines and ore dressing plants includes large amounts of sulphur compounds, such as thiosalts, and nitrogen compounds, such as nitrite, nitrate and ammonia. If the water is discharged directly into the nature without any treatment it will cause acidification and eutrophication. Increasing demand on the removal of the thiosalts and nitrogen compounds has been raised from the authorities. Today, the thiosalts and nitrogen compounds are often removed to a minor extent by natural degradation in the large tailings ponds. However, there are examples where chemical methods, such as the Fenton process, are applied for thiosalts removal. There are also examples where the nitrogen compounds are actively removed in several steps including nitrification and denitrification using a heterotrophic bacteria culture.

Biological denitrification using bacteria cultures is a cost efficient method for nitrate and nitrite removal from most wastewater types. From an article “Denitrification by new strains of thiobacillus denitrificans under non-standard physicochemical conditions, effects of temperature, pH, and sulphur source”, written by C. Trouve, P.M. Chazal, B. Gueroux and N. Saouvaitre, in Environmental Technology, vol. 19, pp 601 - 610, in March 1998, it is known to remove nitrates from water by means of by biological denitrification using Thiobacillus denitrificans as bacteria culture and using a sulphur compounds, for example thiosulphate, as an energy source. The following reaction was suggested to describe the stoichiometry when the bacteria are growing:

0.844 S₂O₃²⁻+NO₃⁻+0.347 CO₂+0.0865 CO₃²⁻+0.0865 NH₄⁺+0.434 H₂O→0.0865 C₅H₇O₂N+0.5 N₂+1.689 SO₄²⁻+0.697 H⁺

As seen from the above formula, carbon dioxide has to be supplied to the process. This process is carried out anaerobically.

From an article “Methabolic changes of Thiobacillus denitrificans accompanying the transition from Aerobic to Anaerobic growth in continuous chemostate culture” by Pauline Justin and D. P. Kelly, in Journal of General Microbiology 107, 131 137, in March 1978, it is known that Thiobacillus denitrificans is capable of rapid growth on thiosulphate both aerobically and anaerobically with nitrate or nitrite as oxidant. The denitrification of nitrate is an anaerobic process and depends strongly on the oxygen concentration in the water. This is disclosed in Table 1 of the article, which exemplifies how the nitrate consumption depends on the concentration of dissolved oxygen. The table shows that the nitrate consumption ceases when the oxygen content in the water exceeds 12 μM/l. The conclusion is that denitrification with thiosulphate as deoxidizing agent ceases when the oxygen content in the water exceeds a low level.

In an article “Combined removal of Sulfur Compounds and Nitrate by Autotrophic Denitrification in Bioaugmented Activated Sludge System” written by I. Manconi, A. Carucci, and P. Lens, published online 9 March 2007 in Wiley Inter Sience (www.interscience.wiley.com) it is proposed to simultaneously remove reduced sulfur compounds and nitrate from waste water by growth of autotrophic sulfur bacteria, such as Thiobacillius Denitrificans, under anaerobic conditions. The reduced sulphur compounds are used for reducing the nitrate and the nitrate is used to oxidize the reduced sulphur compounds. If the amount of sulphur compound and the amount of nitrate in the waste water corresponds to the stoichiometric demand for the nitrogen removal, it is possible to simultaneously remove the reduced sulfur compounds and the nitrate. From the reaction formula described above it is clear that the molar ratio between the amount of reduced sulphur compound and the nitrate must be at least 0,84 in order to achieve a complete removal of the sulphur compound and the nitrate.

This is a quotation from the article: “Thus, to allow maximum NO₃⁻ removal without NO₂⁻ accumulation, the reactor has to be operated in a nitrate limiting mode by addition of electron donor (sulfide or thiosulfate) in excess. However, a careful control of the required electron donor excess is also necessary, since both thiosulfate and sulfide have a chemical oxygen demand (COD), and because below N/S=0.6 elemental sulfur was likely formed during sulfide oxidation. Incomplete oxidation of thiosulfate or sulfide to elemental sulfur would require a separation step of the insoluble elemental sulfur from the wastewater, increasing the process complexity.”

However, in waste water from mines and ore dressing plants the amount of thiosalts in the waste water is normally significantly larger than the stoichiometric demand for the nitrogen removal. For example, the molar ratio between the thiosalts and the nitrogen compounds in the water can be in the order of 10-20. This can be compared with 0.84, which is the stoichiometric demand for nitrate removal when the culture is growing. Although the above described method can be used for complete removal the nitrate in the water, it will only remove a minor part of the thiosalts. Thus, a problem with treating this type of waste water with the above described method is that a major part of the thiosalts will still remain in the water after the treatment.

### OBJECT AND SUMMARY OF THE INVENTION

One object of the present invention is to provide a method for simultaneous removal of thiosalts and nitrogen compounds in waste water where the amount of thiosalts is significantly larger than the stoichiometric demand for the nitrogen removal. This means that the molar ratio between the thiosalts and the nitrogen compounds in the waste water is significantly larger than the ration required for the denitrification process, i.e. larger than 0.84 for nitrate removal.

This object is achieved with a method as defined in claim 1.

The method comprises supplying oxygen to the water, measuring the content of dissolved oxygen in the water, and controlling the content of dissolved oxygen in the water based on the measured content of dissolved oxygen such that the excess of thiosalt is oxidized by the oxygen at the same time as the denitrification process is maintained.

According to the invention, the water is treated using an autotroph culture, for example Thiobacillius Denitrificans, while adding oxygen to the water. A part of the thiosalts is oxidized by the nitrogen compound at the same time as the nitrogen compound is reduced to nitrogen gas by the thiosalts. The excess of thiosalts is oxidized by the added oxygen. The content of dissolved oxygen in the water is controlled so that it does not exceed the level where the denitrification process ceases. The oxygen is added to the water in such a rate that the oxygen content in the water never exceeds the content at which the denitrification ceases. This means that the oxygen is added to the water at about the same rate as it is consumed by the oxidation of the thiosalts. The oxygen can be added to the water, for example, by aeration or injection of oxygen gas. The invention makes it possible to carry out simultaneously denitrification of the nitrogen compound and oxidation of the thiosalts of waste water in which the molar ratio between the thiosalts and the nitrogen compounds is significantly larger than the ratio required for the denitrification process. Thus, an efficient removal of both nitrogen compounds and thiosalts is achieved. It has also been shown that a significant part of the ammonium content of the water is removed according to the above equation, since ammonium is the preferred nitrogen compound for biomass growth.

The following advantages are achieved with the method according to the invention:
Denitrification and oxidation of thiosalts is made in one step.
The method is environmentally friendly since is only requires supply of oxygen, a carbon dioxide source and trace elements when required. No supply of organic compounds, such as methanol, ethanol, or acetate, is needed.
The method is carried out at a neutral pH, which means that the process is less sensitive for metals, fluorine etc. compared to bacterial oxidation of thiosalts carried out at a low pH.
The method according to the invention can be used for treatment of water at temperatures down to temperatures close to 0° C. Thus, denitrification can be carried out efficiently at a lower temperature compared to conventional methods using organic reduction agents. This is advantageous in cold countries, such as the Nordic countries.
Low costs regarding operating economy as well as investments costs, since only one reactor is needed.

The supply of oxygen to the water is controlled so that the content of dissolved oxygen in the water is kept within a certain range. According to an embodiment of the invention, the content of dissolved oxygen is controlled so that it is kept within a range of 0.3-1.5 mg/l, preferably within a range of 0.3-1 mg/l, and most preferably within a range of 0.35-0.6 mg/l.

According to an embodiment of the invention, the method further comprises measuring the UV absorption in the purified water, preferable at a wave length close to the maximum UV absorption of the thiosalts and nitrogen compounds such as nitrate and nitrite, measuring the content of dissolved oxygen in the water, and controlling the supply of oxygen to the water based on the measured UV absorption and the measured oxygen content so that the measured UV absorption is minimized. To achieve a high rate of the removal of both thiosalts and nitrogen compounds, it is important that the control of the oxygen supply is optimized. If the oxygen content in the water is too low, the rate of the oxidation of the thiosalts becomes low, and if the oxygen content in the water is too high, the rate of the denitrification process becomes low. This embodiment improves the control of the oxygen supply to the water and accordingly improves the efficiency of the removal of the thiosalts and the nitrogen compounds in the water. The UV measurement is a measurement of the actual content of thiosalts and nitrogen compounds in the water. If the UV absorption is high, the content of thiosalts and/or nitrogen compounds is high. If the UV absorption is low, the content of thiosalts and/or nitrogen compounds is low. By controlling the supply of oxygen to the water such that the UV absorption of the thiosalts and nitrogen compounds is minimized, an optimal rate of removal of the thiosalts and nitrogen compounds is achieved.

According to an embodiment of the invention, the UV absorption is preferably measured at a wave length in a range of 190-225 nm. The wave length of the maximum UV absorption of thiosalts and nitrogen compounds, such as nitrate and nitrite, is about 214 nm. By on-line-measuring in an interval around 214 nm it is possible to decide whether the remaining content of thiosalts and nitrogen compounds in the purified water is minimized.

According to an embodiment of the invention, the method comprises decreasing the supply of oxygen if the measured UV absorption is high and the content of oxygen is high, e.g. above a limit value, increasing the supply of oxygen if the content of oxygen is low, e.g. below a limit value, and the UV absorption is high, and otherwise maintaining the oxygen supply. By measuring the UV absorption in the purified water at a wave length close to the maximum UV absorption of the thiosalts and nitrogen compounds, it is possible to decide whether the total content of thiosalts and nitrogen compounds in the purified water is minimized. However, it is not possible to decide if it is the thiosalts or the nitrogen compounds that remains, and accordingly it is not possible to decide whether the oxygen supply is to be increased or decreased. By measuring the oxygen content and comparing it with one or more limit values, it is possible to determine whether the oxygen content is too high or too low, and accordingly determine whether the oxygen content is to be increased or decreased. If the oxygen content is too low the rate of oxidation of the thiosalts is too slow, and if the oxygen content is high, the rate of the nitrification is too slow. Thus, by adjusting the supply of oxygen to the water in that way until the absorption is minimize, the rate of removal of the thiosalts and nitrogen compounds is optimized.

According to an embodiment of the invention, the waste water is fed to a bioreactor and the UV absorption at a wave length close to the maximum UV absorption of the thiosalts and nitrogen compounds is measured in the waste water fed to the reactor as well as in the purified water discharged from the reactor, and the supply of oxygen to the water is controlled in dependence of the ratio between the measured UV absorption of the feed and discharged water. This embodiment improves the measurement of the UV absorption, by minimizing the effect of changes in background UV absorption from other compounds in the solution than thiosalts and nitrogen compounds. For process control, it is preferred that the measured UV absorption is on regular basis compared to measured concentration of thiosalts and nitrogen compounds determined by standard analytical procedures.

According to an embodiment of the invention, the method comprises measuring the pH value in the water and supplying a suitable pH regulator to the water to maintain the pH within a range 6-8, and preferably in the range of 6.5-7.5. To avoid further acidification downstream in case of residual thiosalts and nitrogen compounds, the additional pH regulators such as sodium carbonate may be added to buffer the water before the purified water is discharged into the nature.

According to another embodiment of the invention, the autotrophic denitrification process is carried out by a Thiobacillius Denitrificans strain. Preferably, the autotrophic denitrification process is carried out by a psychrophilic or psychrotolerant strain of Thiobacillius Denitrificans. Thiobacillius Denitrificans has been proven to be very suitable to carry out this process since it is active close to 0° C., producing biofilm and active sludge. Another object of the present invention is to provide an apparatus for simultaneous removal of thiosalts and nitrogen compounds in waste water where the amount of thiosalts is larger than the stoichiometric demand for the nitrogen removal.

This object is achieved with an apparatus as defined in claim 9.

The apparatus comprises a bioreactor including an autotrophic bacteria culture carrying out a denitrification process using the thiosalts as electron donors, having an inlet for receiving the waste water, and an outlet for discharging the purified water. The apparatus further comprises an oxygen supply device arranged to supply oxygen to the water in the reactor, a device for measuring the content of dissolved oxygen in the water, and a control unit arranged to control the content of dissolved oxygen in the reactor based on the measured content of dissolved oxygen such that the excess of thiosalts is oxidized by the oxygen at the same time as the denitrification process is maintained.

According to an embodiment of the invention, the apparatus further comprises a device for measuring the content of dissolved oxygen in the reactor and a spectrometer arranged to measure the UV absorption in the purified water at a wave length close to the maximum UV absorption of the thiosalts and nitrogen compounds, and the control unit is arranged to control the supply of oxygen to the water based on the measured UV absorption and the measured oxygen content so that the measured UV absorption is minimized.

According to an embodiment of the invention, the control unit is arranged to control the supply of oxygen to the reactor by decreasing the supply of oxygen if the measured UV absorption is high and the content of dissolved oxygen is above a limit value, and increasing the supply of oxygen if the UV absorption is high and the content of dissolved oxygen is below a limit value, and maintaining the present supply of oxygen if the measured UV absorption is low.

According to an embodiment of the invention, the apparatus comprises devices to retain the biomass, e.g. biofilm carriers or/and downstream facilities to recover and recycle the biomass.

The present invention also relates to the use of the method according to the invention and the apparatus according to the invention for treating waste water from mines and ore dressing plants. The invention is particularly suitable for treatment of waste water from mines and ore dressing plants since the amount of thiosalts usually is significantly larger than the stoichiometric demand for the nitrogen removal in waste water from mines and ore dressing plants.

### BRIEF DESCRIPTION OF THE DRAWINGS

The invention will now be explained more closely by the description of different embodiments of the invention and with reference to the appended figures.

FIG. 1 shows an apparatus for simultaneous removal of thiosalts and nitrogen compounds in waste water according to an embodiment of the invention.

FIG. 2 shows a diagram with examples of UV measurements on waters including different amounts of nitrate and thiosulphate ions.

### DETAILED DESCRIPTION OF PREFERRED EMBODIMENTS OF THE INVENTION

In the following an example is described on how the method according to the invention can be used to remove nitrogen compounds and thiosalts in waste water. In this example, the thiosalts includes thiosulfate and tetrathionate.

The waste water is added to a reactor including an autotroph bacteria culture capable of carrying out a denitrification process. In this example the bacteria culture is Thiobacillius Denitrificans strain. Preferably, the autotrophic denitrification process is carried out by a psychrophilic or psychrotolerant strain of Thiobacillius Denitrificans, or a combination of both. Thiobacillius Denitrificans has been proven to be very suitable to carry out this process since it is active close to 0° C., producing biofilm and active sludge. However, molecular phylogeny of the used culture has been investigated and it shows that other compounds are also present and identified as being related to Lysobacter brunescens and but also to unknown compounds.

The following reaction has been suggested to describe the stoichiometry when bacteria are growing:

0.844 S₂O₃²⁻+NO₃⁻+0.347 CO₂+0.0865 CO₃²⁻+0.0865 NH₄⁺+0.434 H₂O→0.0865 C₅H₇O₂N+0.5 N₂+1.689 SO₄²⁻+0.697 H⁺ (1)

Thus, the expected molar consumption ratio between S₂O₃²⁻ and NO₃⁻ is 0.844 when bacteria are growing.

As seen from formula 1 a carbon dioxide source should be added to the reactor is order to maintain the reaction.

The nitrification process can be carried out even when the biomass is not growing, due to enzymes which are active also without bacterial growth. The following reaction has been suggested to describe the stoichiometry without bacterial growth:

5 S₂O₃²⁻+8 NO₃⁻+H₂O→10 SO₄²⁻+4N₂+2 H⁺ (2)

Thus, the expected molar consumption ratio between S₂O₃²⁻ and NO₃⁻ is 0.625 without bacterial growths. However, in waste water from mines and ore dressing plants the molar ratio between thiosalts and nitrate often is significantly larger than the molar consumption ratio described with the above formulas 1 and 2. Typically, the molar ratio is in the interval of 10-20. Accordingly, the amount of thiosalts in the waste water is significantly larger than the stoichiometric demand for the nitrate removal.

In order to remove the excess of thiosalts, oxygen is added to the water. The oxygen can be added to the water, for example, by aeration or injection of oxygen gas.

The thiosulfate and tetrathionate are oxidized by the added oxygen according to the following stoichiometric reactions.

S₂O₃²⁻+2 O₂+H₂O→2 SO₄²⁻+2 H⁺ (3)

S₄O₆²⁻+3.5 O₂+3 H₂O→4 SO₄²⁻+6 H⁺ (4)

The oxidation converts the thiosulfate and tetrathionate into sulfuric acid. In order to neutralize the sulfuric acid, a pH regulator is added to the water. A suitable pH regulator is carbonate, such as CaCO₃.

CO₃²⁻+H⁺→HCO₃⁻ (5)

This is a part of the reaction described in formula 1.

However, other carbon dioxide sources can be used to neutralize the produced acid, such as CO₂. An advantage with supplying carbonate is that besides the neutralizing effect, it becomes a carbon dioxide source for maintaining the reaction described in formula 1 above. It is also possible to use other types of pH regulators, such as NaOH in combination with carbon dioxide supply. At low biomass growth rate, the carbon dioxide supplied by added air may be sufficient. Typically, air contains 300-400 ppm CO₂.

The pH in the water is controlled so that it is maintained within a range of 6-8, and more preferably within the range of 6.5-7.5. The method may comprise the steps of measuring the pH value in the water, and supplying additional alkali or acid (compared to the stoichiometric demand) if the feed water is too acidic or too alkaline in order to obtain the optimal pH for process.

The content of dissolved oxygen in the water is controlled such that the excess of thiosalts is oxidized by the oxygen at the same time as the denitrification process, as described by formula 1, is maintained. Experimental work has shown that the content of dissolved oxygen is controlled so that it preferably is kept within a range of 0.3-1,5 mg/l, and more preferably is kept within a range of 0.3-0.1 mg/l, and most preferably is kept within a range of 0.35-0.6 mg/l. However, the content of dissolved oxygen which leads to the ceasing of the denitrification process may vary due to the water content and other conditions such as the reactor design with respect to fluid dynamics etc. Preferably, the content of dissolved oxygen which leads to ceasing of the denitrification process is determined for the current water by experiments and optimization.

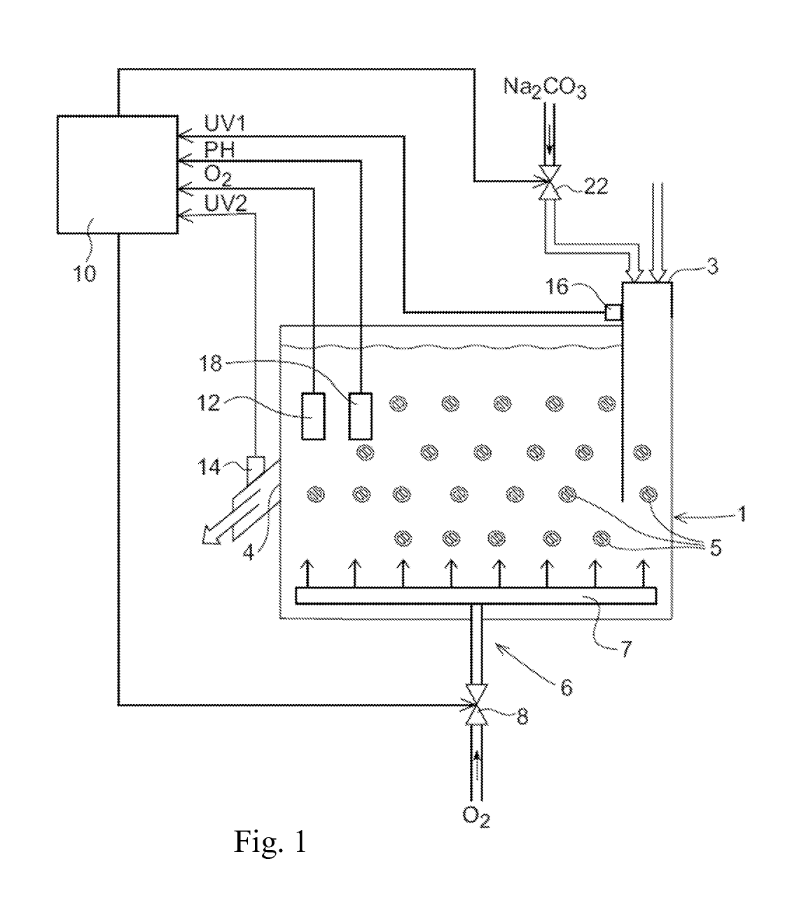

FIG. 1 shows an example of an apparatus for simultaneous removal of thiosalts and nitrogen compounds in waste water according to the invention. The apparatus includes a reactor 1 in the form of a vessel including an autotrophic bacteria culture capable of carrying out a denitrification process using thiosalts as electron donors. In this embodiment of the invention, the reactor is a moving bed bio reactor (MBBR) which includes biofilm carriers 5. By usage of the MBBR technique, only one reactor is needed.

The apparatus has an inlet 3 for receiving waste water, and an outlet 4 for discharging the purified water. The apparatus comprises an oxygen supply device 6 arranged to supply oxygen or air to the water in the reactor. The oxygen supply device 6 includes air spargers 7 arranged in the bottom of the reactor and a device 8 for adjusting the oxygen supply to the reactor, such as a valve. However, the air spargers may also be installed at a higher level.

The apparatus further includes a control unit 10 arranged to control the content of dissolved oxygen in the reactor such that the excess of thiosalts is oxidized by the oxygen at the same time as the denitrification process is maintained. Preferably, several probes for measuring dissolved oxygen are installed at different levels to monitor the dissolved oxygen profile in the reactor. The control unit 10 is, for example, a computer or any other programmable logical device suitable for controlling the process.

To achieve a high rate of the removal of both thiosalts and nitrogen compounds, it is important that the control of the oxygen supply is optimized. If the oxygen content in the water is too low, the rate of the oxidation of the thiosalts becomes low, and if the oxygen content in the water is too high, the rate of the denitrification process becomes low.

The apparatus comprises a measuring device 12, such as a D.O. probe, for measuring the content of dissolved oxygen in the reactor. The measuring device 12 is connected to the control unit 10. The control unit 10 is adapted to receive the measurements of the oxygen content in the reactor and to control the supply of oxygen to the reactor by controlling the valve 8. The apparatus further comprises a spectrometer 14 arranged with a sampling device to measure the UV absorption in the purified water at the outlet 4 of the reactor. The UV absorption is measured at a wave length close to the maximum UV absorption of the thiosalts and nitrogen compounds, i.e. at a wave length close to 214 nm. The spectrometer 14 is connected to the control unit 10. The control unit 10 is arranged to receive the measurements of the UV absorption from the spectrometer 14 and to control the supply of oxygen to the water based on the measured UV absorption and the measured oxygen content so that the measured UV absorption is minimized. The UV measurement is a measurement of the actual content of thiosalts and nitrogen compounds in the water. If the UV absorption is high, the content of thiosalts and/or nitrogen compounds is high. If the UV absorption is low, the content of thiosalts and/or nitrogen compounds is low. By on-line-measuring in an interval around 214 nm it is possible to decide whether the remaining content of thiosalts and nitrogen compounds in the purified water is minimized.

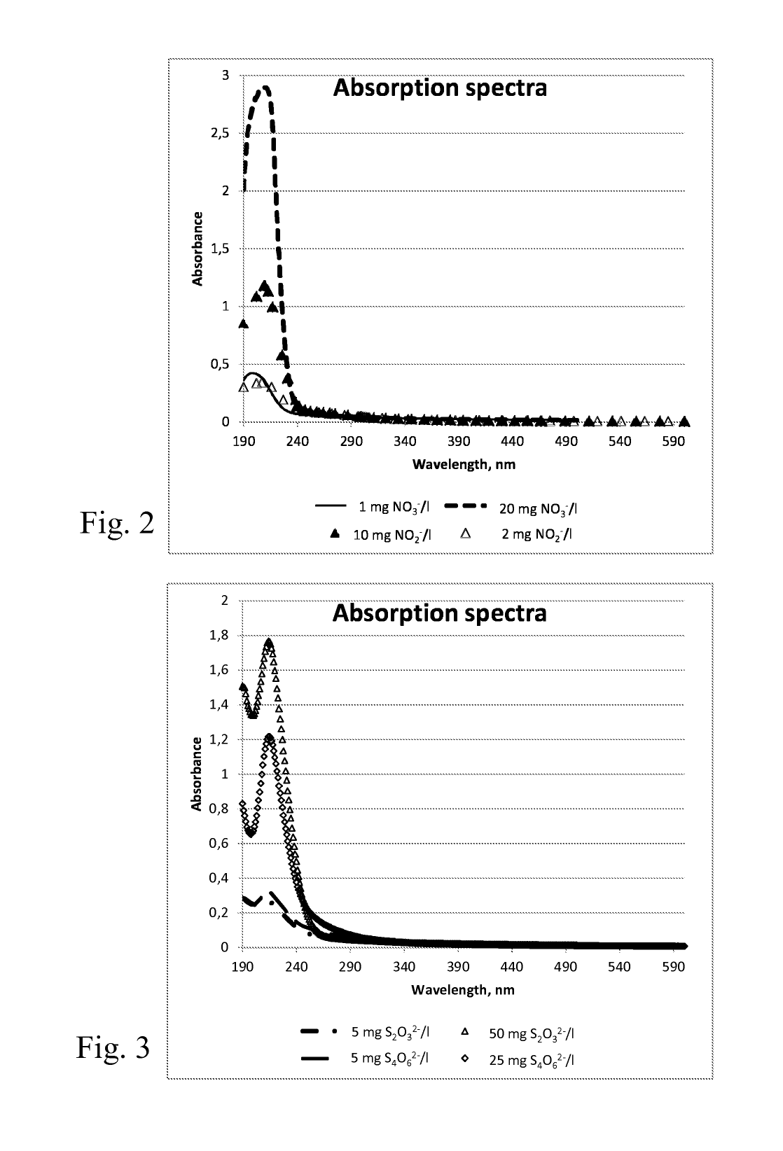

FIG. 2 shows examples of UV measurements on four different solutions. A first solution contains 1 mg NO₃⁻/l and a second solution contains 20 mg NO₃⁻/l. From the diagram it is shown that the UV absorption is significantly lower in the solution containing 1 mg NO₃⁻/l than in the solution containing 20 mg NO₃⁻/l. The UV absorption in the solution containing 20 mg NO₃⁻/l has a peak in the wavelength between 200-220 nm. A third solution contains 5 mg S₂O₃²⁻/l and a fourth solution contains 50 mg S₂O₃²⁻/l. From the diagram it is shown that the UV absorption is significantly lower in the solution containing 5 mg S₂O₃²⁻/l than in the solution containing 50 mg S₂O₃²⁻/l. The UV absorption in the solution containing 50 mg S₂O₃²⁻/l has a peak in the wavelength between 210-220 nm.

However, since both nitrate and thiosulphate have a peak at about 214 nm it is not possible to decide from the UV measurements which one of the thiosalts and nitrogen compounds remains, and accordingly it is not possible to decide whether the oxygen supply is to be increased or decreased. In order to be able to decide whether the oxygen supply is to be increased or decreased the amount of dissolved oxygen in the water is measured. By comparing the measured oxygen content with a limit value, it is possible to determine whether the oxygen content is too high or too low, and accordingly to determine whether the oxygen content is to be increased or decreased. If the oxygen content is too low the rate of oxidation of the thiosalts is too slow, and if the oxygen content is high, the rate of the nitrification is too slow.

The control unit 10 is arranged to control the supply of oxygen to the reactor by decreasing the supply of oxygen if the measured UV absorption is high, i.e. above a first limit value, and the measured content of dissolved oxygen is above a second limit value, and increasing the supply of oxygen if the UV absorption is high and the content of dissolved oxygen is below the second limit value, and maintaining the present supply of oxygen if the measured UV absorption is low, i.e. below the first limit value. By adjusting the supply of oxygen to the water in that way until the absorption is minimize, the rate of removal of the thiosalts and nitrogen compounds is optimized.

The table below shows an example of control of the oxygen supply based on measured UV absorption and measured dissolved oxygen content in the water.

| UV absorption | Oxygen content | Action |
|---|---|---|
| More than 0.5 | More than 0.4 mg/l | Decrease oxygen supply as long |
| | | as the UV absorption decreases |
| More than 0.5 | Less than 0.4 mg/l | Increase oxygen supply as long |
| | | as the UV absorption decreases |
| Less than 0.5 | Independent | Maintain the oxygen supply as |
| | | long as the UV absorption is |
| | | low and stable |

The control unit 10 includes a UV controller adapted to control the UV absorption in the reactor. The control of the oxygen supply is, for example, done by setting a desired value for the UV absorption as a control point for the UV regulator. The content of dissolved oxygen in the reactor becomes an operating range for the UV controller, in which the UV controller searches for an optimal oxygen supply. The oxygen supply is reduced if the oxygen content in the water is high, and the oxygen supply is increased if the oxygen content in the water is low. Thus, the oxygen supply is tuned within the operating range in dependence on the UV response.

In this embodiment of the invention, the UV absorption at a wave length close to the maximum UV absorption of the thiosalts and nitrogen compounds is also measured in the waste water fed to the reactor. The apparatus comprises a second spectrometer 16 arranged to measure the UV absorption in the water at the inlet 4 of the reactor. The second spectrometer 16 is connected to the control unit 10, and the control unit 10 is arranged to receive the measurements of the UV absorption from the first and second spectrometers and to control the supply of oxygen to the water based on the ratio between the measured UV absorption of the feed and discharged water. This improves the measurement of the UV absorption, by minimizing the effect of changes in background UV absorption from other compounds in the solution than thiosalts and nitrogen compounds. For process control, it is preferred that the measured UV absorption is on regular basis compared to measured concentration of thiosalts and nitrogen compounds determined by standard analytical procedures.

The apparatus further comprises a pH control device adapted measure the pH level in the reactor, and to control the pH level in the reactor by supplying a suitable pH regulator to the water in order to maintain an optimal pH value. The pH-control device includes a pH measuring device, such as a pH electrode 18, a source of pH regulator, a device 20 for adjusting the oxygen supply to the reactor, such as a valve 22 connected to the source of pH regulator, and a controller adapted to determine the amount of pH regulator to be supplied to the reactor in order to maintain a neutral pH value in the reactor. Preferably, the pH in the reactor is controlled within a range 6-8, and preferably in the range of 6.5-7.5. In this example, the pH regulator is sodium carbonate (Na₂CO₃), which also functions as a CO₂ source. Alternatively, carbon dioxide (CO₂) in combination with sodium hydroxide (NaOH) or lime can be supplied to the water. In the embodiment disclosed in FIG. 1, the pH controller is implemented in the same control unit 10 as the control the supply of oxygen to the reactor. In an alternative embodiment a separate pH controller can be implemented.

The apparatus may downstream contain a device for recycling biomass to the bioreactor.

The nitrogen and thiosalts removal rate of the process depends on the temperature in the reactor. The process has been proven to work within a temperature interval of 0-20° C. However, the removal rate is higher at a temperature close to 20° C. than close to 0° C. It is likely that other strains can be found to demonstrate the process at higher temperatures.

The following four examples show tests during different conditions and the test results. A Pilot scale 1-stage with 500 liter reactor volume and 60% filling volume of Biocarrier-Anox Kaldnes K1 is used in all examples. HRT stands for the hydraulic retention time.

### Example 1

Process conditions

| HRT | | Temperature | Aeration | D.O |
|---|---|---|---|---|
| hours | pH | ° C. | YES/NO | mg O₂/l |
| 8.3 | 6.8 | 1.5 | YES | 0.60 |

| | | | | |
|---|---|---|---|---|
| NO₃⁻ | NH₄⁺ | NO₂⁻ | S₂O₃²⁻ | S₄O₆²⁻ |
| mg/l | mg/l | mg/l | mg/l | mg/l |

Feed analyses

| | | | | |
|---|---|---|---|---|
| 26.6 | 1.13 | 5.92 | 119.7 | 0.00 |

Residual analyses

| | | | | |
|---|---|---|---|---|
| 0.30 | 0.043 | 2.67 | 2.8 | 0.00 |

Removal

| NO₃⁻ | NH₄⁺ | NO₂⁻ | S₂O₃²⁻ | S₄O₆²⁻ |
|---|---|---|---|---|
| % | % | % | % | % |
| 98.9 | 96.2 | 54.9 | 97.7 | — |

Molar ratio S₂O₃²⁻/NO₃⁻ removal=2.46

Low temperature, balanced oxygen supply→high removal rate of both thiosalts and nitrate

The first example shows that no accumulation of nitrite occurs at optimal conditions.

### Example 2

Process conditions

| HRT | | Temperature | Aeration | D.O |
|---|---|---|---|---|
| hours | pH | ° C. | YES/NO | mg O₂/l |
| 8.3 | 6.8 | 3.1 | YES | 0.19 |

| | | | | |
|---|---|---|---|---|
| NO₃⁻ | NH₄⁺ | NO₂⁻ | S₂O₃²⁻ | S₄O₆²⁻ |
| mg/l | mg/l | mg/l | mg/l | mg/l |

Feed analyses

| | | | | |
|---|---|---|---|---|
| 61.6 | 2.52 | 7.6 | 270.3 | 5.02 |

Residual analyses

| | | | | |
|---|---|---|---|---|
| 0.24 | 0.91 | 0.39 | 102.5 | 2.32 |

Removal

| NO₃⁻ | NH₄⁺ | NO₂⁻ | S₂O₃²⁻ | S₄O₆²⁻ |
|---|---|---|---|---|
| % | % | % | % | % |
| 99.6 | 63.9 | 94.9 | 62.1 | 53.8 |

Molar ratio S₂O₃²⁻/NO₃⁻ removal=1.51

Low temperature, low oxygen supply→low D.O→low residual concentration of nitrate and nitrite, but high residual concentration of thiosalts

### Example 3

Process conditions

| HRT | | Temperature | Aeration | D.O |
|---|---|---|---|---|
| hours | pH | ° C. | YES/NO | mg O₂/l |
| 3.8 | 6.8 | 4.6 | YES | 0.44 |

| | | | | |
|---|---|---|---|---|
| NO₃⁻ | NH₄⁺ | NO₂⁻ | S₂O₃²⁻ | S₄O₆²⁻ |
| mg/l | mg/l | mg/l | mg/l | mg/l |

Feed analyses

| | | | | |
|---|---|---|---|---|
| 68 | 2.42 | 4.1 | 265.5 | 0.00 |

Residual analyses

| | | | | |
|---|---|---|---|---|
| 16.40 | 0.95 | 4.84 | 107.8 | 0.00 |

Removal

| NO₃⁻ | NH₄⁺ | NO₂⁻ | S₂O₃²⁻ | S₄O₆²⁻ |
|---|---|---|---|---|
| % | % | % | % | % |
| 75.9 | 60.7 | Minor formation | 59.4 | — |

Molar ratio S₂O₃²⁻/NO₃⁻ removal=1.69

Low temperature, low retention time, balanced oxygen supply→lowering the removal of thiosalts and nitrate. Minor accumulation of nitrite occurs.

### Example 4

Process conditions

| HRT | | Temperature | Aeration | D.O |
|---|---|---|---|---|
| hours | pH | ° C. | YES/NO | mg O₂/l |
| 7.6 | 6.8 | 13 | YES | 0.39 |

| | | | | |
|---|---|---|---|---|
| NO₃⁻ | NH₄⁺ | NO₂⁻ | S₂O₃²⁻ | S₄O₆²⁻ |
| mg/l | mg/l | mg/l | mg/l | mg/l |

Feed analyses

| | | | | |
|---|---|---|---|---|
| 48.3 | 5.01 | 9.11 | 152.0 | 4.25 |

Residual analyses

| | | | | |
|---|---|---|---|---|
| 2.10 | 3.48 | 9.83 | 4.6 | 0.00 |

Removal

| NO₃⁻ | NH₄⁺ | NO₂⁻ | S₂O₃²⁻ | S₄O₆²⁻ |
|---|---|---|---|---|
| % | % | % | % | % |
| 95.7 | 30.5 | Minor formation | 97.0 | 100.0 |

Molar ratio S₂O₃²⁻/NO₃⁻ removal=1.77

Medium temperature, balanced oxygen supply→high removal rate of both thiosalts and nitrate. Minor accumulation of nitrite occurs.

With a method according to the invention, the removal of thiosalts and nitrogen compounds in waste water is made in one step by a balanced oxygen supply.

In some cases trace elements are added to the waste water. For instance, phosphate can be added if the waste water lacks phosphate.

The present invention is not limited to the embodiments disclosed but may be varied and modified within the scope of the following claims. For example, the method is not limited to MBBR technology. Other methods such as activated sludge process and fix bed reactor are also applicable in order to retain and to control the biomass concentration in the system.

1. A method for simultaneous removal of thiosalts and nitrogen compounds in waste water with an autotrophic denitrification process using the thiosalts as electron donors, wherein the amount of thiosalts in the waste water is larger than the stoichiometric demand for the autotrophic nitrogen removal, said method comprising:
supplying oxygen to the water,
measuring the content of dissolved oxygen in the water, and
controlling the content of dissolved oxygen in the water based on the measured content of dissolved oxygen such that the excess of thiosalts is oxidized by the oxygen at the same time as the denitrification process is maintained.

2. The method according to claim 1, wherein the content of dissolved oxygen is controlled so that it is kept within a range of 0.3-1.5 mg/l.

3. The method according to claim 1, further comprising:
measuring the UV absorption in the water at a wave length close to the Maximum UV absorption of the thiosalts and nitrogen compounds,
measuring the content of dissolved oxygen in the water, and
controlling the supply of oxygen to the water based on the measured UV absorption and the measured oxygen content so that the measured UV absorption is minimized.

4. The method according to claim 3, wherein the UV absorption is measured at a wave length in a range of 190-225 nm.

5. The method according to claim 3, further comprising
decreasing the supply of oxygen if the measured UV absorption is high and the content of oxygen is high,
increasing the supply of oxygen if the UV absorption is high and the content of oxygen low, and
otherwise maintaining the oxygen supply.

6. The method according to claim 3, wherein the waste water is fed to a bioreactor and the UV absorption at a wave length close to the maximum UV absorption of the thiosalts and nitrogen compounds is measured in the waste water fed to the reactor as well as in the purified water discharged from the reactor, and the supply of oxygen to the water is controlled in dependence of the ratio between the measured UV absorption of the feed and discharged water.

7. The method according to claim 1, wherein the method comprises measuring the pH value in the water and supplying a suitable pH regulator to the water to maintain the pH within a range 6-8.

8. The method according to claim 1, wherein the autotrophic denitrification process is carried out by a culture containing a psychrophilic and/or psychrotolerant Thiobacillius Denitrificans strain.

9. An apparatus for simultaneous removal of thiosalts and nitrogen compounds in waste water, wherein the amount of thiosalts in the waste water is larger than the stoichiometric demand for the autotrophic nitrogen removal, the apparatus comprising:
a bioreactor including an autotrophic bacteria culture carrying out a denitrification process using the thiosalts as electron donors, the bioreactor having an inlet for receiving the waste water, and an outlet for discharging the purified water,
an oxygen supply device arranged to supply oxygen to the water in the reactor,
a device for measuring the content of dissolved oxygen in the reactor, and
a control unit arranged to control the content of dissolved oxygen in the reactor based on the measured content of dissolved oxygen such that the excess of thiosalts is oxidized by the oxygen at the same time as the denitrification process is maintained.

10. The apparatus according to claim 9, wherein control unit is arranged to control the content of dissolved oxygen in the reactor so that it is kept within a range of 0.3-1,5 mg/l.

11. The apparatus according to claim 9, wherein the apparatus further comprises a device for measuring the content of dissolved oxygen in the reactor and a device arranged to measure the UV absorption in the purified water at a wave length close to the Maximum UV absorption of the thiosalts and nitrogen compounds, and the control unit is arranged to control the supply of oxygen to the water based on the measured UV absorption and the measured oxygen content so that the measured UV absorption is minimized.

12. The apparatus according to claim 11, wherein the control unit is arranged to control the supply of oxygen to the reactor by decreasing the supply of oxygen if the measured UV absorption is high and the content of dissolved oxygen is high, and increasing the supply of oxygen if the UV absorption is high and the content of dissolved oxygen is low, and maintaining the present supply of oxygen if the measured UV absorption is low.

13. The apparatus according to claim 9, wherein the apparatus further comprises a pH-control device adapted measure the pH level in the reactor and to control the pH level in the reactor by supplying a suitable pH regulator to the water to maintain the pH within a range 6-8.

14. The apparatus according to claim 9, wherein the bioreactor is a moving bed bio reactor which includes biofilm carriers.

15. (canceled)
